(19) United States
(12) Patent Application Publication
(10) Pub. No.: US 2020/0372113 A1
(43) Pub. Date: Nov. 26, 2020

(54) LOG FILE MEANING AND SYNTAX GENERATION SYSTEM

(71) Applicant: SAP SE, Walldorf (DE)

(72) Inventor: Susan Marie Thomas, Karlsruhe (DE)

(21) Appl. No.: 16/422,258

(22) Filed: May 24, 2019

(51) Int. Cl. G06F 17/27; G06F 16/18; G06F 16/13; G06F 16/35

(52) U.S. Cl. CPC G06F 17/2785; G06F 17/271; G06F 17/2735; G06F 16/355; G06F 16/1805; G06F 16/13; G06F 17/2765

(57) ABSTRACT

Systems and methods are provided for parsing a log file to compute a meaning for each event by detecting words in text representing the event and generating a sequence of select words found in the text representing the event, and to compute a syntax for each event by generating an abstract of the text representing the event. The systems and methods further group the events in the log file by meaning and syntax to generate a list of groupings, each grouping of the list of groupings comprising a sequence of select words from the events in the grouping, an abstract for the events in the grouping, and a number of events in the log file that match based on the sequence of select words and abstract.

### BACKGROUND

A log file is a file that records events that occur in an operating system or during operation of one or more software applications, messages between machines in a system, and so forth. A log file can be used to monitor security in a system, monitor performance of a system, audit a system, and the like. For example, a log file can record every time a new user creates a new account, every time a user logs into or out of a system, the amount of time a user is logged into a system, every time a user fails to log in, and so forth. In another example, a log file can record each search, click through, or other activity a user performs via a search engine or website.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is a flow chart illustrating aspects of a method for processing a log file, according to some example embodiments.

FIG. 3 illustrates an example output of a processed log file, according to some example embodiments.

FIG. 4 is a block diagram illustrating an example of a software architecture that may be installed on a machine, according to some example embodiments.

FIG. 5 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to generating a meaning and syntax of events in a log file. As explained above, a log file is a file that records events that occur in an operating system or during operation of one or more software applications, messages between machines in a system, and so forth. A log file can be used to monitor security in a system, monitor performance of a system, audit a system, and the like. For example, a log file can record every time a new user creates a new account, every time a user logs into or out of a system, the amount of time a user is logged into a system, every time a user fails to log in, and so forth. In another example, a log file can record each search, click through, or other activity a user performs via a search engine or website. A log file can capture many thousands of events (or messages) that occur in a system. The challenge is how to use the data or even how to know what information is captured in the data.

For example, a user may wish to find out what information is captured in a particular log file. It not practical to manually go through an entire log file with many thousands of entries and determine what data has been captured. And even if it were practical, it may not be possible to determine all the different types of information captured. If a user knows a specific piece of data he or she may be able to search the log file to try and find the data, but he or she will need to know the specific syntax of the data to get accurate search results. Moreover, a log file may comprise many types of events and a user may only be interested in a subset or one type of event among the many types of events.

Example embodiments address such issues by generating a meaning and syntax of events in a log file and then grouping the events in the log file by meaning and syntax to reduce the log file down to the essential types of events so that a user can get a sense of the information the log file contains and quickly find desired information. For example, example embodiments transform original text corresponding to an event in a log file into a meaning and syntax representing the event and then group the events by meaning and syntax to distill a large log file into a summary of events. For instance, a computing system accesses a log file comprising a listing of events that occurred in one or more computing systems and parses the log file to compute a meaning and a syntax for each event listed in the listing of events. The computing system computes the meaning for each event by detecting words in text representing the event and generating a sequence of select words found in the text representing the event. The computing system computes a syntax for each event by generating an abstract of the text representing the event, the abstract comprising the select words and at least one prespecified character replacing a word or text that is not a select word. In one example, the select words are embedded in a representation that retains punctuation marks and abstractions of the other content (e.g. non-select words or other text) between the punctuation marks. The computing system further groups the events in the log file by meaning and syntax to generate a list of groupings, each grouping of the list of groupings comprising a sequence of select words from the events in the grouping, an abstract for the events in the grouping, and a number of events in the log file that match based on the sequence of select words and abstract, and provides the list of groupings to a computing device.

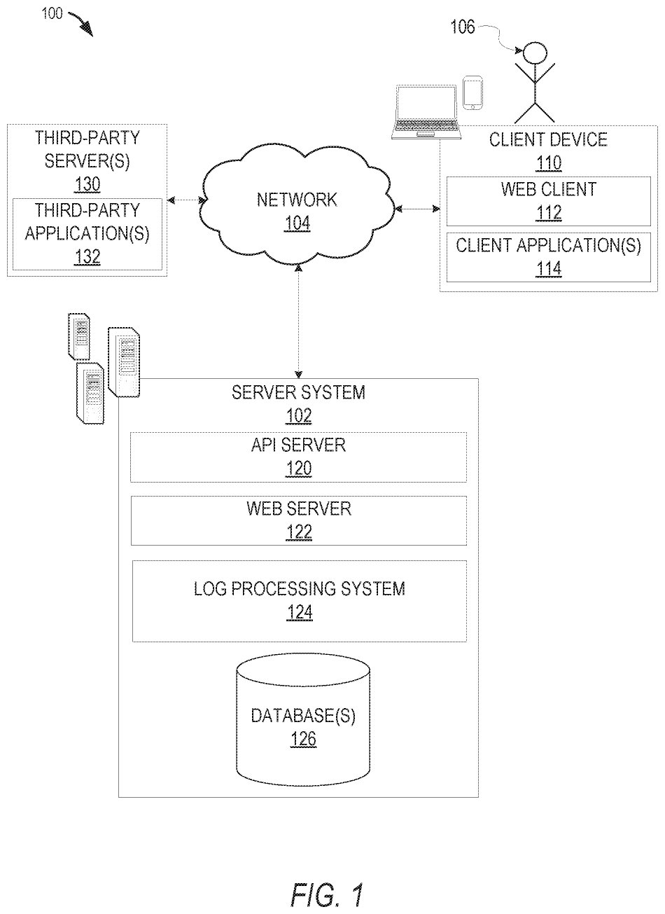

FIG. 1 is a block diagram illustrating a networked system 100, according to some example embodiments. The system 100 may include one or more client devices such as client device 110. The client device 110 may comprise, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100, In some embodiments, the client device 110 may comprise a display module (not shown) to display information (e.g., in the form of user interfaces). In further embodiments, the client device 110 may comprise one or more of touch screens, accelerometers, gyroscopes, cameras, microphones, global positioning system (GPS) devices, and so forth. The client device 110 may be a device of a user 106 that is used to access and utilize cloud services, among other applications.

One or more users 106 may be a person, a machine, or other means of interacting with the client device 110. in example embodiments, the user 106 may not be part of the system 100 but may interact with the system 100 via the client device 110 or other means. For instance, the user 106 may provide input (e.g., touch screen input or alphanumeric input) to the client device 110 and the input may be communicated to other entities in the system 100 (e.g., third-party servers 130, server system 102, etc) via the network 104. In this instance, the other entities in the system 100, in response to receiving the input from the user 106, may communicate information to the client device 110 via the network 104 to be presented to the user 106. In this way, the user 106 may interact with the various entities in the system 100 using the client device 110.

The system 100 may further include a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 may access the various data and applications provided by other entities in the system 100 via web client 112 (e.g., a browser, such as the Internet Explorer® browser developed by Microsoft® Corporation of Redmond, Wash. State) or one or more client applications 114. The client device 110 may include one or more client applications 114 (also referred to as “apps”) such as, but not limited to, a web browser, a search engine, a messaging application, an electronic mail (email) application, an e-commerce site application, a mapping or location application, an enterprise resource planning (ERP) application, a customer relationship management (CRM) application, an analytics design application, a log file analysis application, and the like.

In some embodiments, one or more client applications 114 may be included in a given client device 110, and configured to locally provide the user interface and at least some of the functionalities, with the client application(s) 114 configured to communicate with other entities in the system 100 (e.g., third-party servers 130, server system 102, etc.), on an as-needed basis, for data and/or processing capabilities not locally available (e.g., access location information, access software version information, access an ERP system, access a CRM system, access an analytics design system, access data to respond to a search query, to authenticate a user 106, to verify a method of payment, access test data, access one or more standard automates or related data, etc.). Conversely, one or more applications 114 may not be included in the client device 110, and then the client device 110 may use its web browser to access the one or more applications hosted on other entities in the system 100 (e.g., third-party servers 130, server system 102, etc.).

A server system 102 may provide server-side functionality via the network 104 (e.g., the Internet or wide area network (WAN)) to one or more third- party servers 130 and/or one or more client devices 110. The server system 102 may include an application program interface (API) server 120, a web server 122, and a test adaptation system 124 that may be communicatively coupled with one or more databases 126.

The one or more databases 126 may be storage devices that store data related to users of the system 100, applications associated with the system 100, cloud services, and so forth. The one or more databases 126 may further store information related to third-party servers 130, third-party applications 132, client devices 110, client applications 114, users 106, and so forth. In one example, the one or more databases 126 may be cloud-based storage.

The server system 102 may be a cloud computing environment, according to some example embodiments. The server system 102, and any servers associated with the server system 102, may be associated with a cloud-based application, in one example embodiment.

The log processing system 124 may provide back-end support for third-party applications 132 and client applications 114, which may include cloud- based applications. The log processing system 124 processes log files to generate meaning and syntax for each event in the log files, as described in further detail below. The log processing system 124 may comprise one or more servers or other computing devices or systems.

The system 100 may further include one or more third-party servers 130. The one or more third-party servers 130 may include one or more third-party application(s) 132. The one or more third-party application(s)132, executing on third-party server(s) 130, may interact with the server system 102 via API server 120 via a programmatic interface provided by the API server 120. For example, one or more the third-party applications 132 may request and utilize information from the server system 102 via the API server 120 to support one or more features or functions on a website hosted by the third party or an application hosted by the third party. The third-party website or application 132, for example, may provide log file processing and processing results viewing functionality that is supported by relevant functionality and data in the server system 102.

FIG. 200 is a flow chart illustrating aspects of a method 200 for processing a log file, according to some example embodiments. For illustrative purposes, method 200 is described with respect to the networked system 100 of FIG. 1. It is to be understood that method 200 may be practiced with other system configurations in other embodiments.

In operation 202, a computing system (e.g., server system 102 or log processing system 124) accesses a. log file comprising a listing of events that occurred in one or more computing systems. For example, the computing system may receive a request for analysis of a log file from a computing device (e.g., client device 110) and in response, may access and process the log file. The computing device may access a log file from a data store (e.g., database 126), access a log file that is received from a third-party server 130 or client device 110, or the like. In one example embodiment, the log file is a text file with each event represented as a line in the text file. The text in the file representing the event is also referred to herein as a log line and a line in the text file. In yet other example embodiments, each event may be represented by other means, such as a particular character or symbol to represent the beginning and end of an event, or the like. In other example embodiments, the log file may be another type of file other than a text file.

In operation 204, the computing system parses the log file to compute a meaning and a syntax for each event listed in the list of events. To compute the meaning for each event listed in the list of events, the computing system detects words in the text representing the event and generates a sequence of select words found in the text representing the event. For example, the computer system parses the text representing the event to detect words in the text and ignores punctuation, numbers, or anything that does not look like a word (e.g., alphabetic text).

In one example embodiment, the meaning of a line or text representing the event is represented by a sequence of verbs found in the text representing the event. For example, verbs are found by looking up all alphabetic content (e.g., words) of the line or text representing the event, in a dictionary of verbs. Other words may be added to the dictionary or one or more other dictionaries can be used, but in some example embodiments, verbs are primarily used as select words because the log lines represent events (e.g., things that have happened) and so the core meaning of the text is likely in the verbs of the text. Another reason that verbs are used is that they are more likely not to overlap with variables in the line or text, such as usernames or hostnames. Including such variables in a meaning would lead to extra groups that should have been included in another group (e.g., a group with all the same select words except for the variable(s)).

The below text illustrates an extract of an example dictionary of verbs. In the below example, the dictionary comments begin with an exclamation point (!). Note that the dictionary also includes nouns derived from the verbs (e.g., connection from connect). Note that the dictionary also includes inflected forms of the verbs (e.g., access, accesses, accessing, accessed, etc.).
Verb: infinitive without ‘to’, third-person singular present, present participle, past, past participle
If a hyphen appears it means that the word occurs either with or without it.
e.g., back-up or backup may occur
the hyphen is also a placeholder for missing forms abort, aborts, aborting, aborted, aborted accept, accepts, accepting, accepted, accepted access, accesses, accessing, accessed, accessed account, accounts, accounting, accounted, accounted ack, acks, acking, acked, acked
. . .

In one example embodiment, a configurable option for the dictionary lookup is to include multi-word phrases like verb-preposition combinations such as “timed out” in the example below:

Example line:

pam_systemd(crond:session): Failed to create session: Connection tinted out

In another example embodiment, another option is to look up all words that are computed by considering hyphens and underscores between alphabetic content to be word-internal punctuation. For example, pam_systemd (in the ‘Example line’) would be looked up in the dictionary, in addition to pam and system. Words with underscores often have specific technical meanings, so including them in the dictionary can help find log lines with specific meanings.

In one example embodiment, verbs can be added to the prespecified verb dictionary. In another example embodiment, verbs can be excluded from the results if, for example, they are problematic. For example, “do” is an English verb that matches “Do” which is a German short form of “Donnerstag” (Thursday) which is sometimes seen even in English logs. The verbs to be excluded can be included in a separate dictionary (e.g., an exclusion dictionary) or can just be deleted from the verb dictionary.

In another example, other words that are unlikely to be confused with variables can be added to dictionaries for other word classes. Examples of other word classes include prepositions, nouns, adjectives, and adverbs. In this way, there can be more than one dictionary, such as a verbs dictionary, a prepositions dictionary, a nouns dictionary, an adjectives dictionary, an adverbs dictionary, an exclusions dictionary, and the like. Which dictionary or dictionaries to use can be a configuration option. For example, a system may use all the dictionaries in some example embodiments, or only one or a select set of dictionaries, in other example embodiments. In this way, the system is configurable for different log file types or logging analysis scenarios.

Moreover, dictionaries can represent different languages or a mix of languages. In one example embodiment, the computing system determines the language of the log file (e.g., recognizes the language of the log file based on the text in the log file, naming convention, or other means) and can use the dictionary or dictionaries specific to the recognized language.

Accordingly, the computing system detects each word in the text representing an event (e.g., log line) and looks up each detected word in at least one predefined dictionary. The computing system determines whether each word in the event in the log file is in the at least one predefined dictionary and adds the word to the sequence of the select words (e.g., selects the word) based on determining that the word is in the at least one predefined dictionary (e.g., determining it is a verb). The computing device skips the word or replaces the word with a prespecified character (as described below) based on determining that the word is not in the at least one predefined dictionary. The computing system may also compare the word to words in an exclusion dictionary to determine whether to skip the word or replace the word with a prespecified character as described below.

A syntax of a line or text representing the event is represented by an abstraction of the line. To compute the syntax for each event, the computing system generates an abstract of the text representing the event. The abstract comprises the select words (e.g., verbs or other select words as described above) and any prespecified characters, digits, or symbols which replace words that are not select words (e.g., not in the prespecified dictionary or dictionaries, in the exclusion dictionary, etc.), that are punctuation, that are digits, that are mixed alphabetic and digits, and so forth. Abstracting involves one of several operations. For example, in a first operation the computing system finds successive sequences of punctuation in the line to determine that everything between the punctuation is content. In a second operation, the computing device abstracts the content of the line, leaving the punctuation as is. For example, the computing system replaces content that is not a selected word (e.g., verb). For instance, an ‘a’ can replace alphabetic content that is not in the dictionary; a specified digit, such as an 8, can replace digits since an 8 does not look like an alphabetic character; and a specified character, such as an m, can be used for mixed aiphabetics and digits.

The following illustrates an example meaning and syntax generated from a log line (e.g., text representing an event):
Log Line (without header):
pam_systemd(crond:session): Failed to create session: Connection timed out
Selected Words (e.g., verbs):
Failed, create, Connection, timed
Abstract:
a_a(a:a): Failed a create a: Connection timed a

The above example shows a sequence of select words found in the original log line for the event, namely, “Failed, create, Connection, timed:” The abstract is created keeping the select words and replacing all other words, digits, mixed aiphabetics and digits, and so forth. For example, the words “pam” and “systemd” (or “pam systemd”) are not in the dictionary or dictionaries and thus, are replaced with “a_a.” Likewise, “crond” and “session” are not in the dictionary or dictionaries and thus, are replaced with “a:a.” The word “Failed” is in the dictionary or dictionaries and thus is retained, “to” is not in the dictionary or dictionaries and thus is replaced with “a,” “create” is in the dictionary or dictionaries and is also retained, and so forth. Accordingly, a sequence of select words “Failed, create, Connection, timed” is generated from the original log line (e.g., text representing the event) and the original log line is transformed into the abstract “a_a(a:a): Failed a create a: Connection timed a.” In this example, the punctuation is also maintained (e.g., underscore, open parenthesis, colon, close parenthesis, space, and so forth), and everything in between is retained (if a select word) or abstracted (replaced with a specified character, symbol, or digit).

In one example, punctuation is found using a regex (regular expression) which considers everything other than alphabetic characters and digits to be punctuation. In Python, for example, the regex is [_\W]{1} which explicitly includes the underscore as punctuation because by default, \W does not count an underscore as punctuation.

As the log line is abstracted, alphabetic content is looked up in the verbs dictionary, or other dictionaries, to decide whether to append it to the word sequence that represents the meaning of the line.

In one example, a log that is primarily in one language (e.g., English) can contain other languages in the log file, for example in the variable parts such as a URL. In this example, there are several options for abstracting this case. In one example, the computing system abstracts all alphabetic content per the abstraction process described above. For instance, the computing system abstracts only the character class standardly, for example in English this would be [a-zA-Z], and abstracts all other alphabetic content to a specified symbol or character (e.g., ∝). In another example, the computing system ignores non-English (or non-primary language) content. As with the first example, a dictionary lookup would be performed as described above. Note that if non-English words were added to the dictionary, they would also be included in the meaning and syntax.

Optionally, the computing system abstracts content of syntactic types that have variable length or different abstract content types. This operation, also referred to herein as “secondary abstraction,” applies to syntactic types such as a hostname, MAC address, URL, SQL statement, path, and the like. This operation allows the system to capture more log lines in the same group by abstracting syntactic types that may slightly vary between log lines, Syntactic types whose initial abstraction is variable in form can be abstracted to some invariant form as shown by examples in the following table. This second abstraction is optional for the various syntactic types. Grouping without doing it creates more groups but may compute them more quickly. Secondary abstraction can be extended to other syntactic types.

| Syntactic Type | Invariant Form |
|---|---|
| hostname | a.m |
| MAC address | original form with all m's, |
| | e.g., m:m:m:m:m:m in place of |
| | 00:26:96:FF:FE:12, whose initial |
| | abstract form is 8:8:8:a:a:8 |
| URL | a:// |
| SQL | a SQL statement is replaced by |
| statement | its initial SQL verb |
| Path | /m/m if the path uses forward slashes; |
| | \m\m if the path uses backslashes. |

Each syntactic type has an invariant form. As per the table the invariant form of all hostnames is “a.m”. Example host names include “sap.com,” “sap.com.help,” “sap1.com.help”, whose initial abstractions are “a.a”, “a.a.a” and “m.a.a”, respectively. When the computing system recognizes a host name (e.g., by format), it can abstract the hostname to an invariant form for hostnames, “a.m”. All three hostnames would be become “a.m”. This can be similarly done with URLs where no matter the length of the URL, it is reduced to “a://”.

MAC addresses can be expressed in various ways, as shown by some examples below. The more common forms use colons or dashes.

00:26:96:FF:FE:12

00:26:96:FEFE:12:34:56

0025:96FF:FE12:3456

00-26-96-FF-FE-12

0025.96FF.FE12.3456

As shown above, the computing system can recognize a MAC address (e.g., based on format) and can abstract the MAC address to an invariant form by replacing the original form between punctuation with all m's, for example.

A SQL statement can be replaced by its SQL verb, as shown in the following examples:

DROP TABLE “MYTABLE”;

This SQL statement can be replaced by its SQL verb ‘DROP’.

CREATE SCHEMA “MYSCHEMA”;

This SQL statement can be replaced by its SQL verb ‘CREATE’.

Paths can also be expressed in various ways, as shown in the examples below:

/dir1/dir2/docs/Doc. txt

C:\dir1\dir2\docs\Doc.txt

Similar to the hostname and URL examples, the paths can also be reduced to just /m/m/ or \m\m\ depending on whether the path uses forward or backward slashes.

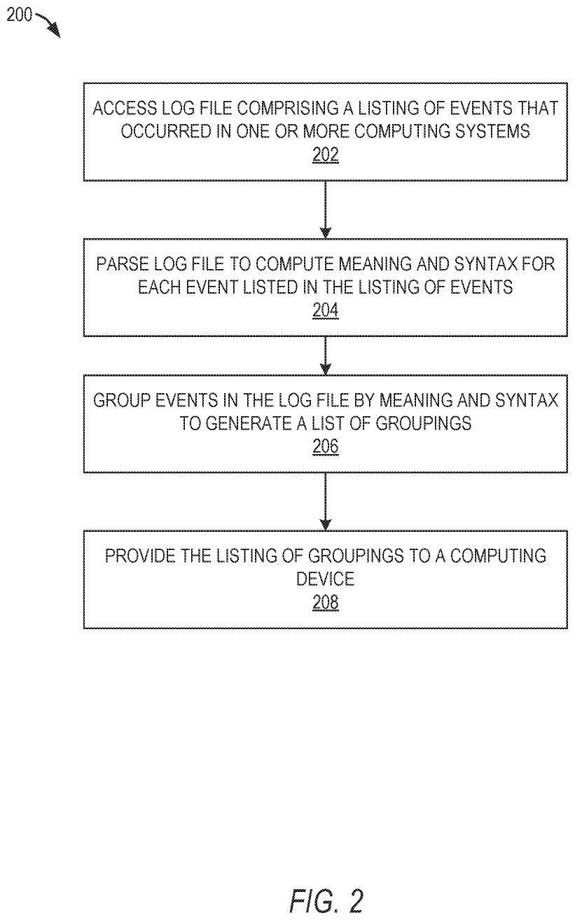

Continuing to refer to FIG. 2, in operation 206, the computing system groups events in the log file by meaning and syntax to generate a list of groupings. For example, each grouping of the list of groupings comprises a sequence of select words common to the events in the grouping, an abstract common to the events in the grouping, and a number of events in the log file that match based on the sequence of select words and abstract.

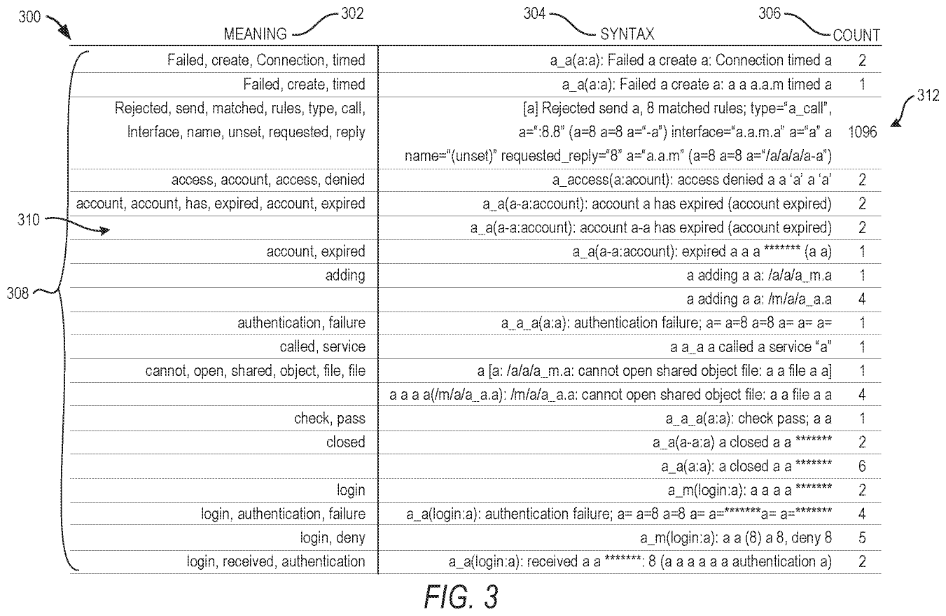

In one example, the computing system groups events in the log file by meaning and syntax to generate a list of groupings by executing a “group by” command by meaning and syntax to generate a list of groupings of selected words (e.g., verbs). This places all the log lines with the same meaning and syntax in one group. FIG. 3 illustrates an example output 300 of a “group by” meaning (e.g., sequence of select words, such as verbs) and syntax (e.g., abstract). In this example, a secondary abstraction was not performed. In the example output 300, the list of groupings is represented by rows 308. Each row of the rows 308 is an individual grouping. Column 302. lists the meaning (e.g., sequence of select words, such as verbs) in the grouping, column 304 lists the syntax (e.g., abstract) in the grouping, and column 306 lists the count for the grouping. The count indicates the number of log lines or events in the log file that match based on the meaning and syntax (e.g., sequence of select words and abstract).

It is noted that some of the meaning column 302 comprises a blank. This indicates that the meaning is the same as the meaning of the previous row but the abstract is different. For example, column 302. for row 310 is blank. This indicates that the meaning is the same as the row above “account, account, has, expired, account, expired” but that the abstract is different (e.g., the abstract for the row above is “a_a(a-a:account): account a has expired (account expired)” and the abstract for row 310 is “a_a(a-a:account): account a-a has expired (account expired)”).

As can be seen by the example output 300 in FIG. 3, the list of groupings basically condenses thousands of log lines into a small table. For example, adding up the count column indicates that the log file contains over a thousand log lines (or events), however, one can quickly see that most events are directed to the meaning of row 312, as indicated by count value 1096.

In operation 208, the computing system provides the listing of groupings to a computing device. In one example, the list of groupings provided to the computing device are displayed on a display of the computing device as a table comprising a row for each grouping and first column for the sequence of select words from the events in the grouping, a second column for the abstract for the events in the grouping, and a third column for the number of events in the log file that match based on the sequence of select words and abstract, as shown in FIG. 3. The table may also list the log lines themselves that correspond to each grouping.

Example embodiments accordingly provide a method of processing a log file to get a quick overview of the log file or log collection by grouping the events (e.g., log lines) by meaning and syntax. For each event or log line, a representation of its meaning and syntax is computed, and then a grouping operation (e.g., SQL group by) is used to group events or log lines by meaning and syntax.

As explained above, computation of meaning and syntax is configurable using options such as which dictionaries to use, which dictionary entries to ignore, whether to compute lookup words with internal hyphens and/or underscores, whether to look for multi-word phrases, how to abstract non-English (or non-primary language) characters, whether and how to perform secondary abstraction, and so forth.

The following examples describe various embodiments of methods, machine-readable media, and systems (e.g., machines, devices, or other apparatus) discussed herein.

### EXAMPLE 1

A computer-implemented method comprising:

accessing a log file comprising a listing of events that occurred in one or more computing systems;

parsing, by one or more processors, the log file to compute a meaning and a syntax for each event listed in the listing of events, by performing operations comprising:
computing a meaning for each event by detecting words in text representing the event and generating a sequence of select words found in the text representing the event; and
computing syntax for each event by generating an abstract of the text representing the event;

grouping the events in the log file by meaning and syntax to generate a list of groupings, each grouping of the list of groupings comprising a sequence of select words from the events in the grouping, an abstract for the events in the grouping, and a number of events in the log file that match based on the sequence of select words and abstract; and

providing the list of groupings to a computing device.

### EXAMPLE 2

A method according to any of the previous examples, wherein computing a meaning for each event by detecting words in text representing the event and generating a sequence of select words found in the text representing the event comprises:

detecting each word in the event in the log file and determining whether each word is in at least one predefined dictionary;

adding the word to the sequence of select words based on determining the word is in the at least one predefined dictionary; and

skipping the word based on determining the word is not in the at least one predefined dictionary.

### EXAMPLE 3

A method according to any of the previous examples, wherein computing the syntax for each event by generating an abstract of the text representing the event further comprises:

replacing the word with a prespecified character if the word is not in the at least one predefined dictionary to generate text comprising the select words and one or more prespecified characters; and

generating the abstract of the text representing the event using the text comprising the select words and one or more prespecified characters.

### EXAMPLE 4

A method according to any of the previous examples,er comprising:

replacing any digits in the text representing the event with a prespecified digit; and

wherein generating the abstract of the text representing the event further comprises using the text comprising select words, one or more specified characters, and any prespecified digits.

### EXAMPLE 5

A method according to any of the previous examples, further comprising:

replacing any mixed alphabetic and digits with a second prespecified character; and

wherein generating the abstract of the text representing the event further comprises using the text comprising select words, one or more specified characters, any prespecified digits, and any second prespecified characters.

### EXAMPLE 6

A method according to any of the previous examples, wherein generating the abstract of the text representing the event further comprises maintaining the punctuation of the text representing the event.

### EXAMPLE 7

A method according to any of the previous examples, wherein grouping the events in the log file by meaning and syntax to generate a list of groupings comprises performing a group by command by meaning and syntax to generate a list of groupings of verbs.

### EXAMPLE 8

A method according to any of the previous examples, wherein the list of groupings provided to the computing device are displayed on a display of the computing device as a table comprising a row for each grouping and first column for the sequence of select words from the events in the grouping, a second column for the abstract for the events in the grouping, and a third column for the number of events in the log file that match based on the sequence of select words and abstract.

### EXAMPLE 9

A system comprising:

a memory that stores instructions; and

one or more processors configured by the instructions to perform operations comprising:

accessing a log file comprising a listing of events that occurred in one or more computing systems;

parsing the log file to compute a meaning and a syntax for each event listed in the listing of events, by performing operations comprising:
computing a meaning for each event by detecting words in text representing the event and generating a sequence of select words found in the text representing the event; and
computing syntax for each event by generating an abstract of the text representing the event;

grouping the events in the log file by meaning and syntax to generate a list of groupings, each grouping of the list of groupings comprising a sequence of select words from the events in the grouping, an abstract for the events in the grouping, and a number of events in the log file that match based on the sequence of select words and abstract; and

providing the list of groupings to a computing device.

### EXAMPLE 10

A system according to any of the previous examples, wherein computing a meaning for each event by detecting words in text representing the event and generating a sequence of select words found in the text representing the event comprises:

detecting each word in the event in the log file and determining whether each word is in at least one predefined dictionary;

adding the word to the sequence of select words based on determining the word is in the at least one predefined dictionary; and skipping the word based on determining the word is not in the at least one predefined dictionary.

### EXAMPLE 11

A system according to any of the previous examples, wherein computing the syntax for each event by generating an abstract of the text representing the event further comprises:

replacing the word with a prespecified character if the word is not in the at least one predefined dictionary to generate text comprising the select words and one or more prespecified characters; and

generating the abstract of the text representing the event using the text comprising the select words and one or more prespecified characters.

### EXAMPLE 12

A system according to any of the previous examples, the operations further comprising:

replacing any digits in the text representing the event with a prespecified digit; and

wherein generating the abstract of the text representing the event further comprises using the text comprising select words, one or more specified characters, and any prespecified digits.

### EXAMPLE 13

A system according to any of the previous examples, the operations further comprising:

replacing any mixed alphabetic and digits with a second prespecified character; and

wherein generating the abstract of the text representing the event further comprises using the text comprising select words, one or more specified characters, any prespecified digits, and any second prespecified characters.

### EXAMPLE 14

A system according to any of the previous examples, wherein generating the abstract of the text representing the event further comprises maintaining the punctuation of the text representing the event.

### EXAMPLE 15

A system according to any of the previous examples, wherein grouping the events in the log file by meaning and syntax to generate the list of groupings comprises performing a group by command by meaning and syntax to generate a list of groupings of verbs.

### EXAMPLE 16

A system according to any of the previous examples, wherein the list of groupings provided to the computing device are displayed on a display of the computing device as a table comprising a row for each grouping and first column for the sequence of select words from the events in the grouping, a second column for the abstract for the events in the grouping, and a third column for the number of events in the log file that match based on the sequence of select words and abstract.

### EXAMPLE 17

A non-transitory computer-readable medium comprising instructions stored thereon that are executable by at least one processor to cause a computing device to perform operations comprising:

accessing a log file comprising a listing of events that occurred in one or more computing systems;

parsing the log file to compute a meaning and a syntax for each event listed in the listing of events, by performing operations comprising:
computing a meaning for each event by detecting words in text representing the event and generating a sequence of select words found in the text representing the event; and
computing syntax for each event by generating an abstract of the text representing the event;

grouping the events in the log file by meaning and syntax to generate a list of groupings, each grouping of the list of groupings comprising a sequence of select words from the events in the grouping, an abstract for the events in the grouping, and a number of events in the log file that match based on the sequence of select words and abstract; and

providing the list of groupings to a computing device.

### EXAMPLE 18

A non-transitory computer-readable medium according to any of the previous examples, wherein computing a meaning for each event by detecting words in text representing the event and generating a sequence of select words found in the text representing the event comprises:

detecting each word in the event in the log file and determining whether each word is in at least one predefined dictionary;

adding the word to the sequence of select words based on determining that the word is in the at least one predefined dictionary; and

skipping the word based on determining that the word is not in the at least one predefined dictionary.

### EXAMPLE 19

A non-transitory computer-readable medium according to any of the previous examples, wherein computing the syntax for each event by generating an abstract of the text representing the event further comprises:

replacing the word with a prespecified character if the word is not in the at least one predefined dictionary to generate text comprising the select words and one or more prespecified characters; and

generating the abstract of the text representing the event using the text comprising the select words and the one or more prespecified characters.

### EXAMPLE 20

A non-transitory computer-readable medium according to any of the previous examples, wherein the list of groupings provided to the computing device are displayed on a display of the computing device as a table comprising a row for each grouping and first column for the sequence of select words from the events in the grouping, a second column for the abstract for the events in the grouping, and a third column for the number of events in the log file that match based on the sequence of select words and abstract.

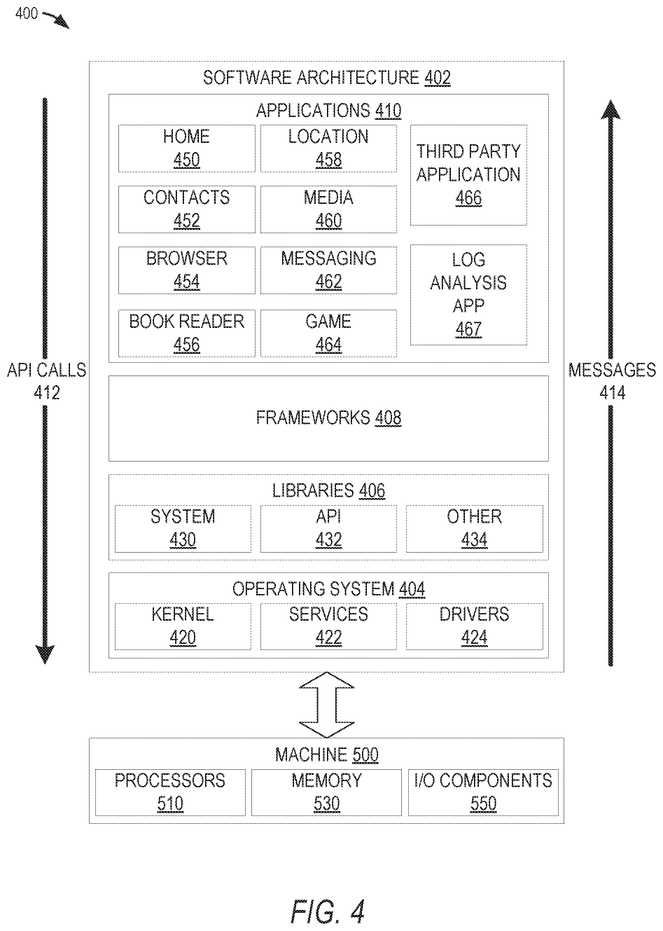

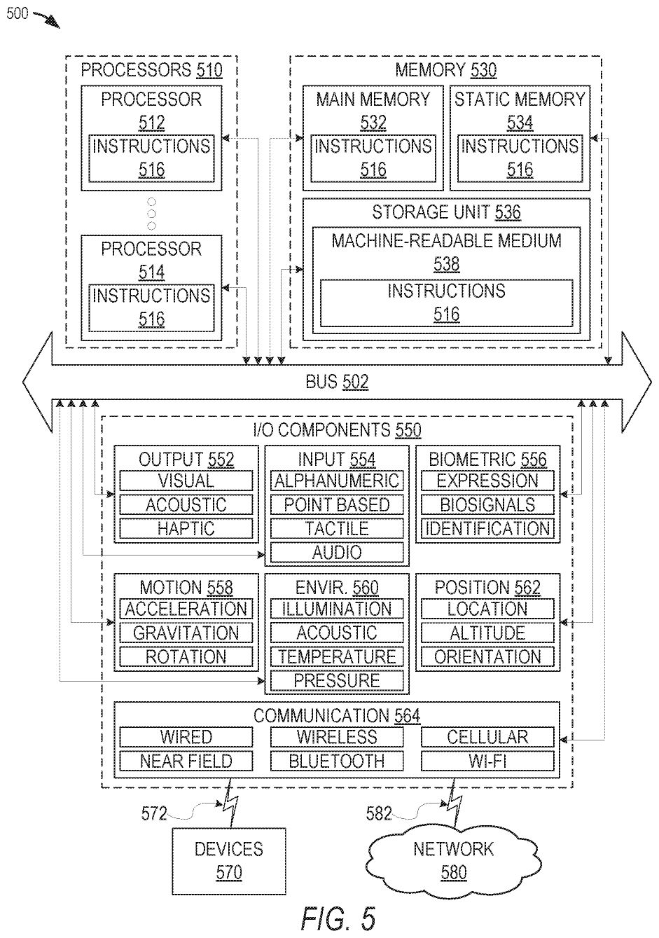

FIG. 4 is a block diagram 400 illustrating software architecture 402, which can be installed on any one or more of the devices described above. For example, in various embodiments, client devices 110 and servers and systems 130, 102, 120, 122, and 124 may be implemented using some or all of the elements of software architecture 402. FIG. 4 is merely a non-limiting example of a software architecture, and it will be appreciated that many other architectures can be implemented to facilitate the functionality described herein. In various embodiments, the software architecture 402 is implemented by hardware such machine 500 of FIG. 5 that includes processors 510, memory 530, and I/O components 550. In this example, the software architecture 402 can be conceptualized as a stack of layers where each layer may provide a particular functionality. For example, the software architecture 402 includes layers such as an operating system 404, libraries 406, frameworks 408, and applications 410. Operationally, the applications 410 invoke application programming interface (API) calls 412 through the software stack and receive messages 414 in response to the API calls 412, consistent with some embodiments.

In various implementations, the operating system 404 manages hardware resources and provides common services. The operating system 404 includes, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking, and security settings, among other functionality. The services 422 can provide other common services for the other software layers. The drivers 424 are responsible for controlling or interfacing with the underlying hardware, according to some embodiments. For instance, the drivers 424 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 406 can also include a wide variety of other libraries 434 to provide many other APIs to the applications 410.

The frameworks 408 provide a high-level common infrastructure that can be utilized by the applications 410, according to some embodiments. For example, the frameworks 408 provide various graphic user interface (GUI) functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications such as a third-party application 466. According to some embodiments, the applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOT™ software development kit (SDK) by an entity other than the vendor of the particular platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

Some embodiments may particularly include log analysis application 467. In certain embodiments, this may be a stand-alone application that operates to manage communications with a server system such as third-party servers 130 or server system 102. In other embodiments, this functionality may be integrated with another application. The log analysis application 467 may request and display various data related to processing log files and may provide the capability fur a user 106 to input data related to the objects via a touch interface, keyboard, or using a camera device of machine 500, communication with a server system via I/O components 550, and receipt and storage of object data in memory 530. Presentation of information and user inputs associated with the information may be managed by log analysis application 467 using different frameworks 408, library 406 elements, or operating system 404 elements operating on a machine 500.

FIG. 5 is a block diagram illustrating components of a machine 500, according to some embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application 410, an applet, an app, or other executable code) for causing the machine 500 to perform any one or more of the methodologies discussed herein can be executed. In alternative embodiments, the machine 500 operates as a standalone device or can be coupled (e.g., networked) to other machines. In a networked deployment, the machine 500 may operate in the capacity of a server machine 130, 102, 120, 122, 124, etc., or a. client device 110 in a server-client network environment, or as a peer machine in a peer-to-peer (or distributed) network environment. The machine 500 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

In various embodiments, the machine 500 comprises processors 510, memory 530, and I/O components 550, which can be configured to communicate with each other via a bus 502. In an example embodiment, the processors 510 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 512. and a processor 514 that may execute the instructions 516. The term “processor” is intended to include multi-core processors 510 that may comprise two or more independent processors 512, 514 (also referred to as “cores”) that can execute instructions 516 contemporaneously. Although FIG. 5 shows multiple processors 510, the machine 500 may include a single processor 510 with a single core, a single processor 510 with multiple cores (e.g., a multi-core processor 510), multiple processors 512, 514 with a single core, multiple processors 512, 514 with multiples cores, or any combination thereof.

The memory 530 comprises a main memory 532, a static memory 534, and a storage unit 536 accessible to the processors 510 via the bus 502, according to some embodiments. The storage unit 536 can include a machine-readable medium 538 on which are stored the instructions 516 embodying any one or more of the methodologies or functions described herein. The instructions 516 can also reside, completely or at least partially, within the main memory 532, within the static memory 534, within at least one of the processors 510 (e.g., within the processor's cache memory), or any suitable combination thereof, during execution thereof by the machine 500. Accordingly, in various embodiments, the main memory 532, the static memory 534, and the processors 510 are considered machine-readable media 538.

As used herein, the term “memory” refers to a machine-readable medium 538 able to store data temporarily or permanently and may be taken to include, but not be limited to, random-access memory (RAM), read-only memory (ROM), buffer memory, flash memory, and cache memory. While the machine-readable medium 538 is shown, in an example embodiment, to be a single medium, the term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions 516, when executed by one or more processors of the machine 500 (e.g., processors 510), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 550 include a wide variety of components to receive input, provide output, produce output, transmit information, exchange information, capture measurements, and so on. In general, it will be appreciated that the I/O components 550 can include many other components that are not shown in FIG. 5. The I/O components 550 are grouped according to functionality merely for simplifying the following discussion, and the grouping is in no way limiting. In various example embodiments, the I/O components 550 include output components 552 and input components 554. The output components 552 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 554 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 550 include biometric components 556, motion components 558, environmental components 560, or position components 562, among a wide array of other components. For example, the biometric components 556 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 include acceleration sensor components (e.g., accelerometer), gravitation sensor components, rotation sensor components (e.g., gyroscope), and so forth, The environmental components 560 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 562 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 550 may include communication components 564 operable to couple the machine 500 to a network 580 or devices 570 via a coupling 582 and a coupling 572, respectively. For example, the communication components 564 include a network interface component or another suitable device to interface with the network 580. In further examples, communication components 564 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 570 may be another machine 500 or any of a wide variety of peripheral devices (e.g., a peripheral device coupled via a Universal Serial Bus (USB)).

Moreover, in some embodiments, the communication components 564 detect identifiers or include components operable to detect identifiers. For example, the communication components 564 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 564, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 580 can be an ad hoc network, an intranet, an extranet, a virtual private network (VPN), a local area network (LAN), a wireless LAN (WLAN), a wide area network (WAN), a wireless WAN (WAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 580 or a portion of the network 580 may include a wireless or cellular network, and the coupling 582 may be a Code Division Multiple Access (CDMA) connection, a Global System for Mobile communications (GSM) connection, or another type of cellular or wireless coupling. In this example, the coupling 582 can implement any of a variety of types of data transfer technology, such as Single Carrier Radio Transmission Technology (1xRTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 516 are transmitted or received over the network 580 using a transmission medium via a network interface device (e.g., a network interface component included in the communication components 564) and utilizing any one of a number of well-known transfer protocols (e.g., Hypertext Transfer Protocol (HTTP)). Similarly, in other example embodiments, the instructions 516 are transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

Furthermore, the machine-readable medium 538 is non-transitory (in other words, not having any transitory signals) in that it does not embody a propagating signal. However, labeling the machine-readable medium 538 “non-transitory” should not be construed to mean that the medium is incapable of movement; the medium 538 should be considered as being transportable from one physical location to another. Additionally, since the machine-readable medium 538 is tangible, the medium 538 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
accessing a log file comprising a listing of events that occurred in one or more computing systems;
parsing, by one or more processors, the log file to compute a meaning and a syntax for each event listed in the listing of events, by performing operations comprising:
computing a meaning for each event by detecting words in text representing the event and generating a sequence of select words found in the text representing the event; and
computing syntax for each event by generating an abstract of the text representing the event;
grouping the events in the log file by meaning and syntax to generate a list of groupings, each grouping of the list of groupings comprising a sequence of select words from the events in the grouping, an abstract for the events in the grouping, and a number of events in the log file that match based on the sequence of select words and abstract; and
providing the list of groupings to a computing device.

2. The method of claim I, wherein computing a meaning for each event by detecting words in text representing the event and generating a sequence of select words found in the text representing the event comprises:
detecting each word in the event in the log file and determining whether each word is in at least one predefined dictionary;
adding the word to the sequence of select words based on determining the word is in the at least one predefined dictionary; and
skipping the word based on determining the word is not in the at least one predefined dictionary.

3. The method of claim 2, wherein computing the syntax for each event by generating an abstract of the text representing the event comprises:
replacing the word with a prespecified character if the word is not in the at least one predefined dictionary to generate text comprising the select words and one or more prespecified characters; and
generating the abstract of the text representing the event using the text comprising the select words and the one or more prespecified characters.

4. The method of claim 3, further comprising:
replacing any digits in the text representing the event with a prespecified digit; and
wherein generating the abstract of the text representing the event further comprises using the text comprising select words, the one or more specified characters, and any prespecified digits.

5. The method of claim 4, further comprising:
replacing any mixed alphabetic and digits with a second prespecified character; and
wherein generating the abstract of the text representing the event further comprises using the text comprising select words, the one or more specified characters, any prespecified digits, and any second prespecified characters.

6. The method of claim I, wherein generating the abstract of the text representing the event further comprises maintaining the punctuation of the text representing the event.

7. The method of claim 1, wherein grouping the events in the log file by meaning and syntax to generate a list of groupings comprises performing a group by command by meaning and syntax to generate a list of groupings of verbs.

8. The method of claim 1, wherein the list of groupings provided to the computing device are displayed on a display of the computing device as a table comprising a row for each grouping and first column for the sequence of select words from the events in the grouping, a second column for the abstract for the events in the grouping, and a third column for the number of events in the log file that match based on the sequence of select words and abstract.

9. A system comprising:
a memory that stores instructions; and
one or more processors configured by the instructions to perform operations comprising:
accessing a log file comprising a listing of events that occurred in one or more computing systems;
parsing the log file to compute a meaning and a syntax for each event listed in the listing of events, by performing operations comprising:
computing a meaning for each event by detecting words in text representing the event and generating a sequence of select words found in the text representing the event; and
computing syntax for each event by generating an abstract of the text representing the event;
grouping the events in the log file by meaning and syntax to generate a list of groupings, each grouping of the list of groupings comprising a sequence of select words from the events in the grouping, an abstract for the events in the grouping, and a number of events in the log file that match based on the sequence of select words and abstract; and
providing the list of groupings to a computing device.

10. The system of claim 9, wherein computing a meaning for each event by detecting words in text representing the event and generating a sequence of select words found in the text representing the event comprises:
detecting each word in the event in the log file and determining whether each word is in at least one predefined dictionary;
adding the word to the sequence of select words based on determining the word is in the at least one predefined dictionary; and
skipping the word based on determining the word is not in the at east one predefined dictionary.

11. The system of claim 10, wherein computing the syntax for each event by generating an abstract of the text representing the event further comprises:
replacing the word with a prespecified character if the word is not in the at least one predefined dictionary to generate text comprising the select words and one or more prespecified characters; and
generating the abstract of the text representing the event using the text comprising the select words and the one or more prespecified characters.

12. The system of claim 11, the operations further comprising:
replacing any digits in the text representing the event with a prespecified digit; and
wherein generating the abstract of the text representing the event further comprises using the text comprising select words, the one or more specified characters, and any prespecified digits.

13. The system of claim 12, the operations further comprising:
replacing any mixed alphabetic and digits with a second prespecified character; and
wherein generating the abstract of the text representing the event further comprises using the text comprising select words, the one or more specified characters, any prespecified digits, and any second prespecified characters.

14. The system of claim 9, wherein generating the abstract of the text representing the event further comprises maintaining the punctuation of the text representing the event.

15. The system of claim 9, wherein grouping the events in the log file by meaning and syntax to generate the list of groupings comprises performing a group by command by meaning and syntax to generate a list of groupings of verbs.

16. The system of claim 9, wherein the list of groupings provided to the computing device are displayed on a display of the computing device as a table comprising a row for each grouping and first column for the sequence of select words from the events in the grouping, a second column for the abstract for the events in the grouping, and a third column for the number of events in the log file that match based on the sequence of select words and abstract.

17. A non-transitory computer-readable medium comprising instructions stored thereon that are executable by at least one processor to cause a computing device to perform operations comprising:
accessing a log file comprising a listing of events that occurred in one or more computing systems;
parsing the log file to compute a meaning and a syntax for each event listed in the listing of events, by performing operations comprising:
computing a meaning for each event by detecting words in text representing the event and generating a sequence of select words found in the text representing the event; and
computing syntax for each event by generating an abstract of the text representing the event;
grouping the events in the log file by meaning and syntax to generate a list of groupings, each grouping of the list of groupings comprising a sequence of select words from the events in the grouping, an abstract for the events in the grouping, and a number of events in the log file that match based on the sequence of select words and abstract; and
providing the list of groupings to a computing device.

18. The non-transitory computer-readable medium of claim 17, wherein computing a meaning for each event by detecting words in text representing the event and generating a sequence of select words found in the text representing the event comprises:
detecting each word in the event in the log file and determining whether each word is in at least one predefined dictionary;
adding the word to the sequence of select words based on determining that the word is in the at least one predefined dictionary; and
skipping the word based on determining that the word is not in the at least one predefined dictionary.

19. The non-transitory computer-readable medium of claim 18, wherein computing the syntax for each event by generating an abstract of the text representing the event further comprises:
replacing the word with a prespecified character if the word is not in the at least one predefined dictionary to generate text comprising the select words and one or more prespecified characters; and
generating the abstract of the text representing the event using the text comprising the select words and the one or more prespecified characters.

20. The non-transitory computer-readable medium of claim 17, wherein the list of groupings provided to the computing device are displayed on a display of the computing device as a table comprising a row for each grouping and first column for the sequence of select words from the events in the grouping, a second column for the abstract for the events in the grouping, and a third column for the number of events in the log file that match based on the sequence of select words and abstract.
